(19) United States
(12) Patent Application Publication
(10) Pub. No.: US 2008/0229212 A1
(43) Pub. Date: Sep. 18, 2008

(54) Screen data generating apparatus, image processor, screen data generating method, and computer program product

(75) Inventor: Akira Miyazaki, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/073,940

(22) Filed: Mar. 12, 2008

(30) Foreign Application Priority Data
Mar. 17, 2007 (JP) 2007-069692

(51) Int. Cl. G06F 3/00

(52) U.S. Cl. 715/744

(57) ABSTRACT

Structure definition information defining element layout positions on the screen, element definition information defining contents of the display elements, and layout definition information defining which of the display elements is to be laid out on which of the element layout positions are acquired. The screen data is generated by laying out the display elements in the element layout positions on the screen according to the layout definition information.

### CROSS-REFERENCE TO RELATED APPLICATIONS

The present application claims priority to and incorporates by reference the entire contents of Japanese priority document 2007-069692 filed in Japan on Mar. 17, 2007.

### BACKGROUND OF THE INVENTION

1. Field of the Invention

The present invention relates to a screen data generating apparatus, an image processor, a screen data generating method, and a computer program product.

2. Description of the Related Art

A graphical user interface (GUI) screen of a display unit is available to display various data and receive operational requests from a user.

The GUI screen can be designed by laying out components such as buttons that receive user's operational requests and character display frames for content display. In recent years, there have been increasing demands for customization in which a user creates a GUI matching with his or her purpose, instead of simply using a vendor product.

Examples of a known technology for the GUI customization are disclosed in Japanese Patent Application Laid-open No. 2005-45370 and Japanese Patent Application Laid-open No. 2006-345256.

In Japanese Patent Application Laid-open No. 2005-45370, an image forming apparatus is disclosed in which selecting a panel customizing mode enables changing of functional key settings such as a display or non-display status, a position, and a size on the screen of a liquid crystal display unit.

In Japanese Patent Application Laid-open No. 2006-345256, a technology is disclosed in which a user has an ID card that stores his or her own GUI screen data, and when the user logs on to a multi function printer (MFP) using the ID card, the MFP displays the GUI screen for the user based on the screen data stored in the ID card. Additionally, a technology is also disclosed in which the ID card stores a script for generating a GUI screen data, and the user's GUI screen is displayed based on the screen data automatically generated according to the script.

However, in the display screen customization using the technology of Japanese Patent Application Laid-open No. 2005-45370, when a change is added that influences many keys, such as rearranging the keys or making some keys not be displayed and displaying the remaining keys while shifting the positions thereof close to each other, the position and the size of each key need to be designated one by one, which makes editing operation troublesome. Furthermore, in a case of a plurality of display screens to be used, customization for each screen is necessitated, which also leads to a bothering editing.

Those problems occur also in the editing of display screens other than GUI. Japanese Patent Application Laid-open No. 2006-345256 does not disclose any concrete solution to the problems.

### SUMMARY OF THE INVENTION

It is an object of the present invention to at least partially solve the problems in the conventional technology.

According to an aspect of the present invention, there is provided a screen data generating apparatus that generates screen data that defines a content of a screen and includes a plurality of display elements. The screen data generating apparatus includes a structure-definition-information acquiring unit that acquires structure definition information that defines a plurality of element layout positions on the screen; an element-definition-information acquiring unit that acquires element definition information that defines contents of the display elements to be laid out on the screen; a layout-definition-information acquiring unit that acquires layout definition information that defines which of the display elements is to be laid out on which of the element layout positions; and a screen data generating unit that generates the screen data by laying out the display elements in the element layout positions on the screen according to the layout definition information.

According to another aspect of the present invention, there is provided a method of generating screen data that defines a content of a screen and includes a plurality of display elements to be displayed on a display unit. The method includes acquiring structure definition information that defines a plurality of element layout positions on the screen; acquiring element definition information that defines contents of the display elements to be laid out on the screen; acquiring layout definition information that defines which of the display elements is to be laid out on which of the element layout positions; and generating the screen data by laying out the display elements in the element layout positions on the screen according to the layout definition information.

According to still another aspect of the present invention, there is provided a computer program product including a computer usable medium having computer readable program codes embodied in the medium that, when executed, causes a screen data generating apparatus to execute the above method of generating screen data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a hardware structure of an image processor according to a first embodiment of the present invention;

FIG. 2 is a schematic diagram of an example of a screen displayed on an operation panel of FIG. 1;

FIG. 3 is an example of an example of a performance of a pull-down button laid out on a screen of FIG. 2;

FIG. 4 is a schematic diagram of an example of a performance of a button;

FIG. 5 is a schematic diagram of another example of a performance of a button;

FIG. 6 is a schematic diagram of an example of structure definition information used to generate data of the screen of FIG. 2;

FIG. 7 is a schematic diagram of a screen structure defined by the structure definition information of FIG. 6;

FIG. 8 is a schematic diagram of an example of element definition information used to generate data of the screen of FIG. 2;

FIG. 9 is a schematic diagram of another example of the element definition information;

FIG. 10 is a schematic diagram of an example of layout definition information used to generate data of the screen of FIG. 2;

FIG. 11 is a flowchart of processings executed by a CPU when the image processor allows a display unit to display a screen;

FIG. 12 is a flowchart of screen construction processing according to the layout definition information;

FIG. 13 is a flowchart of drawing processing according to the element definition information;

FIG. 14 is a flowchart of interrupt processing of a saved display element;

FIG. 15 is a schematic diagram of an example of layout definition information different from that of FIG. 10;

FIG. 16 is a schematic diagram of an example of a screen generated by the layout definition information of FIG. 15;

FIG. 17 is a schematic diagram of another example of the layout definition information;

FIG. 18 is a schematic diagram of an example of a screen generated by the layout definition information of FIG. 17;

FIG. 19 is a schematic diagram of an example of layout definition information used by an image processor according to a second embodiment of the present invention;

FIG. 20 is a flowchart of screen generating processing according to the layout definition information, which is executed by the image processor according to the second embodiment of the present invention;

FIG. 21 is a flowchart of layout processing of a group display element;

FIG. 22 is a flowchart of interrupt processing of a saved group element;

FIG. 23 is a schematic diagram of an example of a screen generated by the layout definition information of FIG. 19;

FIG. 24 is a schematic diagram of an example of layout definition information different from that of FIG. 19; and

FIG. 25 is a schematic diagram of an example of a screen generated by the layout definition information of FIG. 24.

### DETAILED DESCRIPTION OF THE PREFERRED EMBODIMENTS

Exemplary embodiments of the present invention are explained in detail with reference to the accompanying drawings.

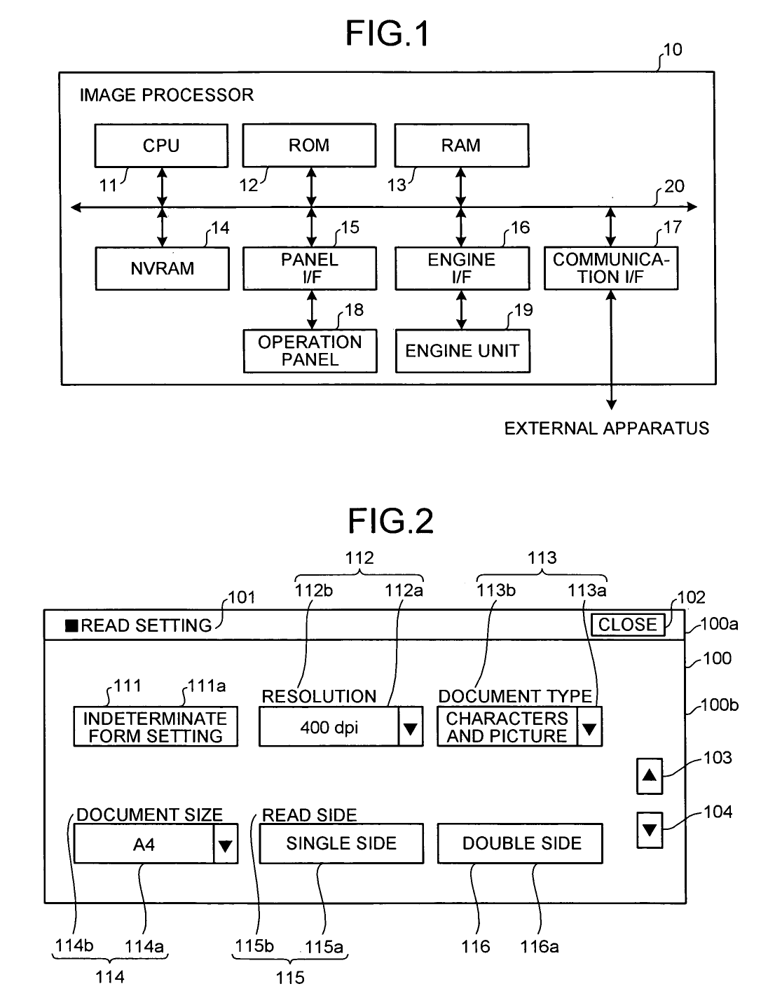

FIG. 1 is a block diagram of a hardware structure of an image processor 10 according to a first embodiment of the invention. As shown in FIG. 1, the image processor 10 includes a central processing unit (CPU) 11, a read-only memory (ROM) 12, a random access memory (RAM) 13, a non-volatile random access memory (NVRAM) 14, a panel interface (I/F) 15, an engine I/F 16, and a communication I/F 17, which are mutually connected by a system bus 20. Additionally, an operation panel 18 is connected to the panel I/F 15, and an engine unit 19 is connected to the engine I/F 16.

The CPU 11 performs an overall control of the image processor 10 and executes computer programs stored in the ROM 12 and the NVRAM 14 to achieve the control function thereof. The CPU 11 also functions as a screen data generating apparatus that generates screen data for defining a screen content displayed on a display unit.

The ROM 12 is a nonvolatile memory unit that stores computer programs executed by the CPU 11 and fixed parameters or the like. The RAM 13 is a memory unit that temporarily stores data used and also functions as a work memory of the CPU 11. The NVRAM 14 is a rewritable nonvolatile memory unit that stores computer programs to be rewritten among computer programs executed by the CPU 11 and parameters necessary to be stored after the image processor 10 is turned off.

The panel I/F 15 is an interface that connects the operation panel 18 to the system bus 20 to allow the CPU 11 to control the panel.

The operation panel 18 includes a liquid crystal display (LCD) that displays a graphical screen, the display unit having a light-emitting diode (LED) or the like, and an operating unit having operating keys and buttons, a touch panel mounted on the LCD, and the like. The LCD displays a screen defined by various data described below as a graphical user interface (GUI) and receives a user's operation on the screen.

The engine I/F 16 is an interface that connects the engine unit 19 to the system bus 20 to allow the CPU 11 to control the engine unit 19. The engine unit 19 is an image processing unit that includes a scanner engine and a print engine to read and print images, or the like. Based on the user's operation executed by the operation panel 18 or a command received from an external device through the communication I/F 17, the CPU 11 controls the engine unit 19 to execute image reading, printing, copying, transmitting, and the like.

The communication I/F 17 is an interface that allows the image processor 10 to communicate with other apparatus via any communications channel. For example, the communication I/F 17 serves as a network interface connected to a local area network (LAN) or the like for Ethernet (registered trademark) communications. Additionally, any external apparatus such as a personal computer (PC) communicable through the communication I/F 17 can access the image processor 10 to give an instruction or change a setting thereof.

In the image processor 10, characteristics are the format of data defining a screen content displayed on the operation panel 18 and a method that generates display screen data from the data.

FIG. 2 is a schematic diagram of an example of a screen displayed on the operation panel 18. A read setting screen 100 of FIG. 2 is one of GUI screens used to receive the settings of image reading by the image processor 10. On the GUI screen, the following display components are arranged along with a background including a title unit 100a on the upper side and a main display unit 100b on the lower side.

The title unit 100a includes a screen title message 101 and a close button 102. The main display unit 100b includes page feeding buttons 103 and 104, an indeterminate form setting button 111a, a resolution setting button 112a, a document type setting button 113a, a document size setting button 114a, a single-side setting button 115a, and a double-side setting button 116a. Additionally, the buttons 112a to 115a include corresponding title messages 112b to 115, respectively.

Each of the buttons 112a to 115a and each of the corresponding title messages 112b to 115b form each of display elements 112 to 115 describer below. The indeterminate form setting button 111a and the double-side setting button 116a independently form display elements 111 and 116 describer below, respectively.

The display components of FIG. 2 are roughly classified into three groups of a message, a button, and a pull-down button. Appearances of the display components are defined by each group. For example, only a text is displayed in the message group; a caption text is displayed on a button graphic in the button group; and in the pull-down button group, a text indicating a current choice is displayed in a box arranged next to a downward-triangular button having a caption.

Each of the display components can be associated with any computer program. Then, when the operation of a display component is performed by touching or otherwise selecting a position corresponding to the display component, the CPU 11 executes a computer program associated with the display component to perform processings such as changing a display content on a screen, moving to another screen, changing settings, or job executing. Thereby, the GUI operation can be associated with performance of the image processor 10. Some display components can be associated with no performance of the image processor 10. Additionally, it is obvious that any display component other than those explained can also be considered.

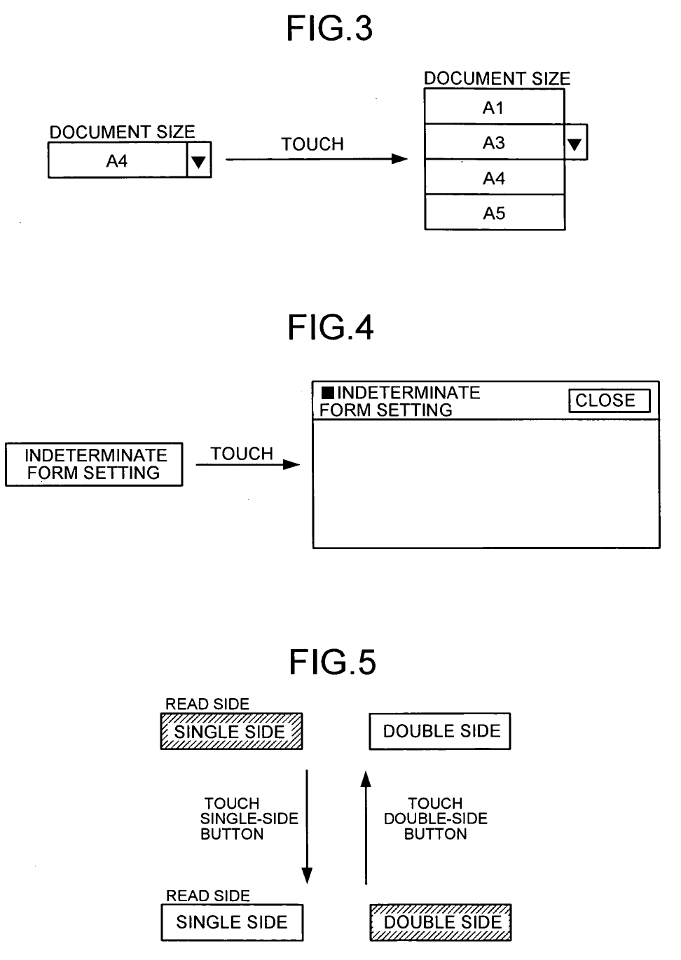

FIGS. 3 to 5 are schematic diagrams of examples of performances according to operations to the display components on the screen. FIG. 3 is a schematic diagram of an example of a performance of the pull-down button. When a user touches the pull-down button, as shown in FIG. 3, a list of values settable for a corresponding item is displayed, thereby allowing the user to select performance for the item from them. Among the display components of FIG. 2, the resolution setting button 112a, the document type setting button 113a, and the document size setting button 114a are associated with the performance.

FIG. 4 is a schematic diagram of an example of a performance of a button. When the command button is touched, as shown in FIG. 4, the operation panel 18 displays another screen to receive a more detailed setting of a corresponding item. Among the display components of FIG. 2, the indeterminate form setting button 111a is associated with the performance.

FIG. 5 is a schematic diagram of another example of a performance of a button. In FIG. 5, two buttons are used as radio buttons for alternatively selecting the value of a single item. In this case, one of the two buttons is shown as a display pattern (indicated by hatching in FIG. 5) that represents a pressed-down condition in which a corresponding value is selected, whereas the other button is shown as a pattern that represents a non-selection condition.

When the non-selection button is touched, the pressed-down condition of the selection button is cancelled to perform a change to display the pressed-down condition of the touched button. Accordingly, it is also possible to associate a pair of display components with such a single performance.

Among the display components of FIG. 2, the single-side setting button 115a and the double-side setting button 116a are associated with the performance. Additionally, a performance other than those exemplified can be associated with the display components. For example, the close button 102 is associated with a performance of closing the read setting screen 100 to return to a previous screen. In addition, when all of display elements to be displayed on the read setting screen 100 cannot be displayed on a single screen, the page feeding buttons 103 and 104 switch the display screen to a previous or next page to show display elements that are not displayed thereon.

The image processor 10 generates display screen data based on three kinds of data including structure definition information, layout definition information, and element definition information prepared as data that define the contents of various screens such as the read setting screen 100. The contents and the use of the data are explained.

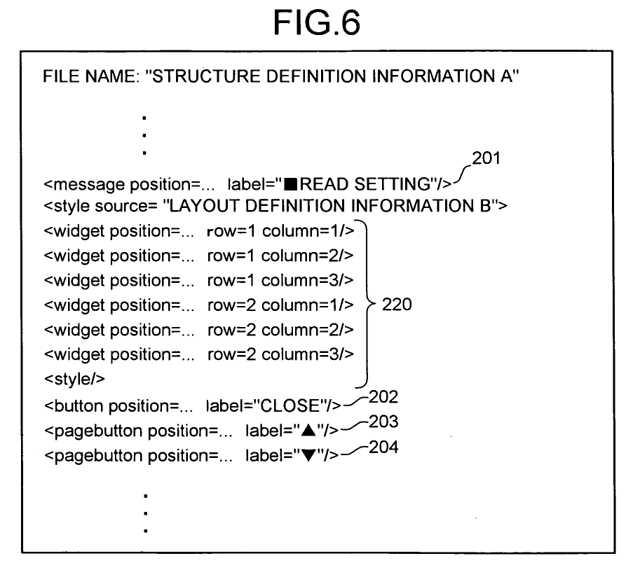

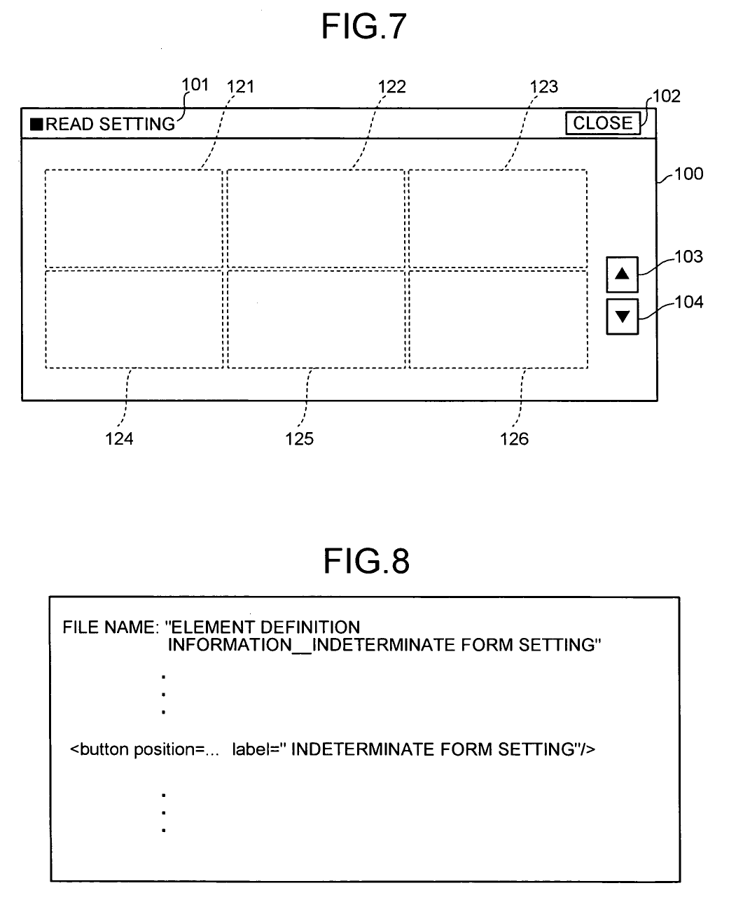

FIG. 6 is a schematic diagram of an example of the structure definition in formation, and FIG. 7 is a schematic diagram of a screen structure defined by the structure definition information. The structure definition information of FIG. 6 is a data that defines the layouts of a plurality of reference positions (element layout positions) on a screen and display components laid out fixedly on the screen to determine a screen structure. In FIG. 6, data for displaying the screen display of FIG. 2 is shown as an example.

The data is described using Extensible Markup Language (XML). In FIG. 6, only elements that describe information relating to the reference positions and the fixed display components are shown, and others are omitted. The reference positions are used for laying out display elements on a screen. In the data of FIG. 6, a style element 220 is data that indicate the layout of the reference positions. The style element 220 includes widget elements, and a single widget element indicates the information of a single reference position.

Based on a position attribute value, the widget element defines a rectangular display area as a reference position. In FIG. 6, a concrete format of the display area is not shown, however can be defined, for example, according to the coordinates of a specific apex (for example, a left upper apex) and a size of the area or the coordinates of two apexes on a diagonal line. The coordinates designated are absolute coordinates on the screen defined by the structure definition information.

Six widget elements are provided in the style element 220. The widget elements define display areas 121 to 126 arranged in a matrix of two rows and three columns, as shown by dotted lines in FIG. 7. Each widget element includes values of a row attribute representing a row number and a column attribute representing a column number to indicate a position of each display area in the matrix. The row number is a value that indicates a vertical position and the column number is a value that indicates a horizontal position in FIG. 6.

Moreover, the display areas of the widget elements are prioritized according to the described order of the widget elements. Then, display elements are laid out in each display area in the order of descending priorities. In the example of FIG. 6, layout of the display elements is started from a first row and a first column of the matrix to lay out the elements in each column of the first row from left to right. Then, in the same manner, the display elements are laid out also in each column of the next row. Accordingly, first, the widget elements that indicate display areas from the first to the third columns of the first row are described, which is followed by descriptions of the widget elements that indicate display areas from the first to the third columns of a second row.

A source attribute of the style element 220 describes a value that specifies layout definition information referred to when laying out a display element in the display area defined by each widget element. The value can be described as a file name of the layout definition information, for example. The display elements 111 to 116 of FIG. 2 are laid out in the display areas 121 to 126 according to the layout definition information.

Among the elements shown in FIG. 6, a message element 201, a button element 202, and pagebutton elements 203 and 204 are each information that indicates the layout of a single display component. Namely, they respectively represent the layout of the screen title message 101, the close button 102, and the page feeding buttons 103 and 104 of FIG. 7.

The kind of a tag that describes each of the elements 201 to 204 represents the kind of the component, such as a message or button. A position attribute value indicates a layout position of a display component on the screen by the absolute coordinates on the screen defined by the structure definition information. A label attribute value indicates the content of a caption text displayed with the component. The other attributes of each element can also be described. For example, information of a computer program to be run upon operation of the display component represented by each element can be described in the tag.

Basically, the display component represented by each element is laid out on the screen regardless of the layout content of a display element in the display area defined by the style element 220. However, a page element for page switching is laid out only when not all the display elements to be laid out in the display area according to the layout definition information can be laid out therein, and otherwise the page element is not laid out. When all of the display elements can be laid out in the display areas, they can all be displayed on a single page screen. Therefore, page switching is not necessitated.

Furthermore, upon processing of the structure definition information by the CPU 11, the image processor 10 can determine which component is a page element and which is not according to the kind of the tag. In a range shown in FIG. 6, the pagebutton elements 203 and 204 are equivalent to page element information indicating the layout of the page element.

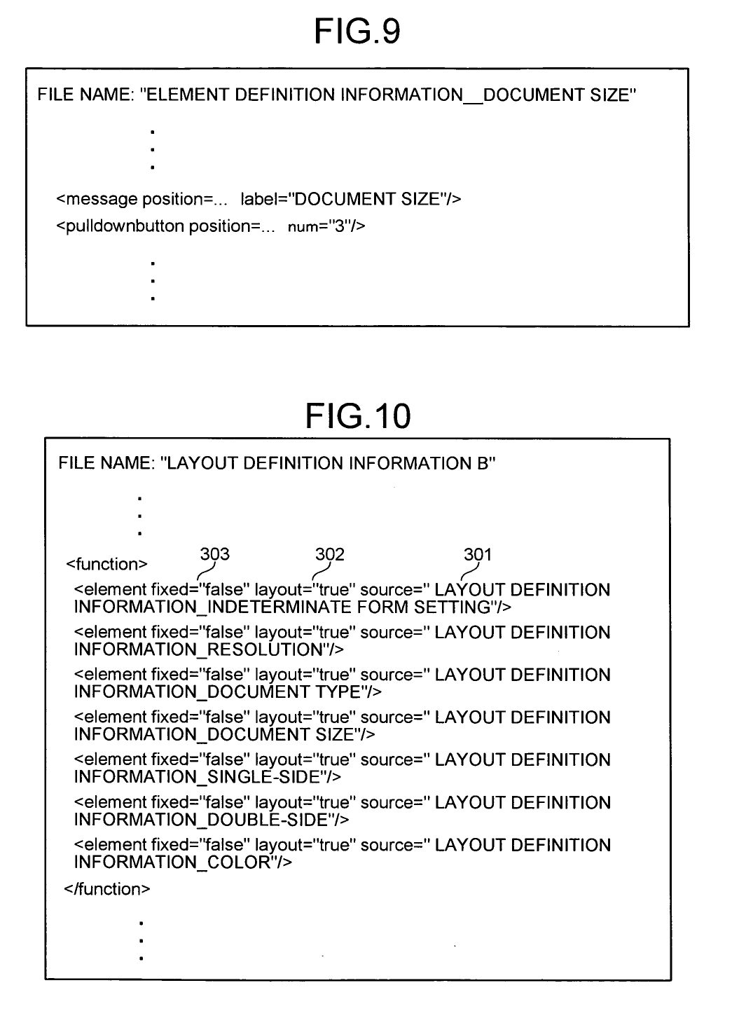

FIGS. 8 and 9 are schematic diagrams of examples of element definition information. The element definition information shown in FIGS. 8 and 9 is data that define the content of a display element laid out in a display area defined by the structure definition information on the screen. As in the case of the screen definition information of FIG. 7, the element definition information is also data using XML language, and defines the content of a display element as the kind and the position of the display component to be laid out in a display area, a caption text, or the like, according to the same tags (for example, message or button) as those used in the screen definition information. In FIGS. 8 and 9, only elements that describe information of the display component are shown, and the others are omitted.

The position attribute value of each element included in the element definition information indicates coordinates within a display area of a layout destination. Thus, on the entire screen, the coordinates are equivalent to relative coordinates with respect to predetermined reference coordinates according to the display area.

In FIG. 8, data is shown that indicates the indeterminate form setting element 111 of FIG. 2. In this case, a display component laid out in the display area is only the indeterminate form setting button 111a having a caption text of “indeterminate form setting”. Thus, a single button element that represents the indeterminate form setting button 111a is described in the element definition information.

In FIG. 9, data is shown that indicates the document size setting button 114a of FIG. 2. In this case, two display components of a title message 114b and the document size setting button 114a are laid out in the display area. Accordingly, a message element and a pulldownbutton element representing those display components are described in the element definition information. In this manner, a single display element can include a plurality of display components.

A pulldownbutton tag shown in FIG. 9, which is not used in the example of FIG. 7, indicates the pull-down button explained in FIG. 3. A num attribute value of the pulldownbutton element indicates the ordinal position of an option selected from those listed in a pull-down menu, and a character string as the option is used as the caption text of the pull-down button. The content of the option can be described as an attribute of the pulldownbutton element or a subelement thereof, although the description of the content is not shown in the drawing.

FIG. 10 is a schematic diagram of an example of the layout definition information. The layout definition information in FIG. 10 is data that define a layout rule for the layout of a display element defined by the element definition information in an on-screen display area defined by the structure definition information. In FIG. 10, the data used for the display of the screen of FIG. 2 is also shown. The element definition information is XML data, as in the screen definition information of FIG. 7. In FIG. 10, only an element describing the definition of the layout rule is shown, and others are omitted.

In the data shown in FIG. 10, a function element indicates a display element to be laid out in a display area (the example of FIG. 7 has the six display areas) defined by a single style element in the screen definition information. Each subelement of the function element includes layout rule information relating to a single display element. The number of the subelements is arbitrarily set regardless of the number of display areas for layout.

In each subelement, a source attribute 301 describes a value that specifies element definition information defining the content of a display element laid out in the display area. The value can be described, for example, as the file name of the element definition information. In the image processor 10, display elements are laid out in an order designated by a subelement described at the head of the character string. Thus, the described order of the subelements indicates the layout order of the display elements in the display area.

A layout attribute 302 of the subelement describes a setting that indicates the presence or absence of layout of a display element represented by the subelement. The value of “true” indicates the presence of layout, and thus, the display element represented by the subelement is laid out in the display area. If the value is “false”, it indicates the absence of layout and thus no layout is performed. Thereby, a subsequent display element is shifted to and laid out in the blank display area.

Accordingly, for example, when a display element representing a button which is not used is set to absence of layout, an unnecessary button is not displayed on the screen, which leads to simplification of the screen and easier operation. Additionally, without any change other than changing a single attribute, another element can be shifted to be displayed. As a result, no unnecessary blank is formed on the screen, thereby facilitating editing of the screen where only necessary buttons organized in compact are laid out. Furthermore, because the display element can be removed from the screen while leaving the subelement, re-display of the display element can be easily done only by changing the value of the subelement.

A fixed attribute 303 of the subelement describes a setting that indicates whether the display element represented by the subelement is fixed. The value of “true” indicates that the element is fixed, and thus, the display element represented thereby is surely laid out in a specified display area. If the value is “false”, it indicates that the element is not fixed, and thus, the display element represented thereby can be laid out in any display area.

In the case of “fixed” the display area for laying out the display element has a priority order equal to the layout order designated by the described order of the subelement. For example, a display element represented by the subelement thirdly described is always laid out in a third display area if “fixed” is set.

The setting of “fixed” is important when the absence of layout is set for a display element prior to the display element set to be fixed. As explained above, when there is a display element not to be laid out, the sequential display element is shifted to the blank area, whereby the layout positions of the display elements are changed. However, even in this case, a display element set to “fixed” can always be laid out at the same position.

Therefore, for example, when the positional change of a button is undesirable because of operational inconvenience or the like, setting the button to “fixed” allows only the specified button to be always displayed in the same position, while other buttons are shifted to the blank display areas to be displayed. Thus, operability can be improved, as well as the advantage due to the presence or absence of layout setting can be obtained.

When the “fixed” is set, an arbitrary designation of a display area for layout can also be considered.

Next, processings for generating data displayed on the screen of the display unit of the operation panel 1-8 by using the structure definition information, the element definition information, and the layout definition information are explained. The processings shown in flowcharts described below are those of an image data generating method according to an embodiment of the invention.

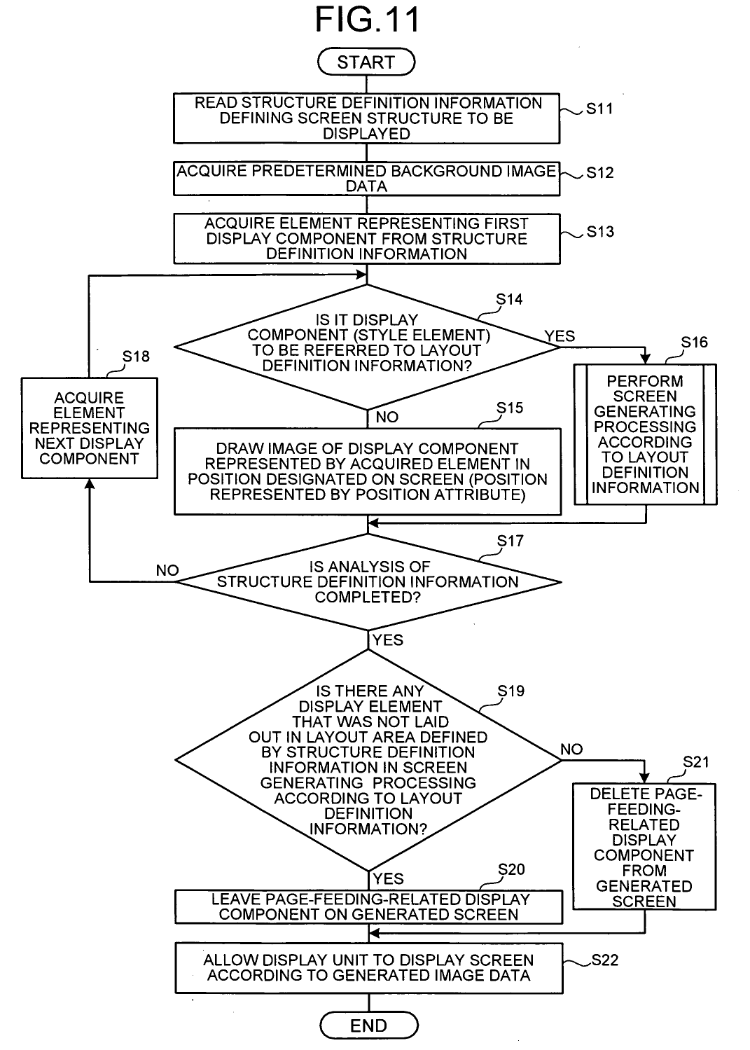

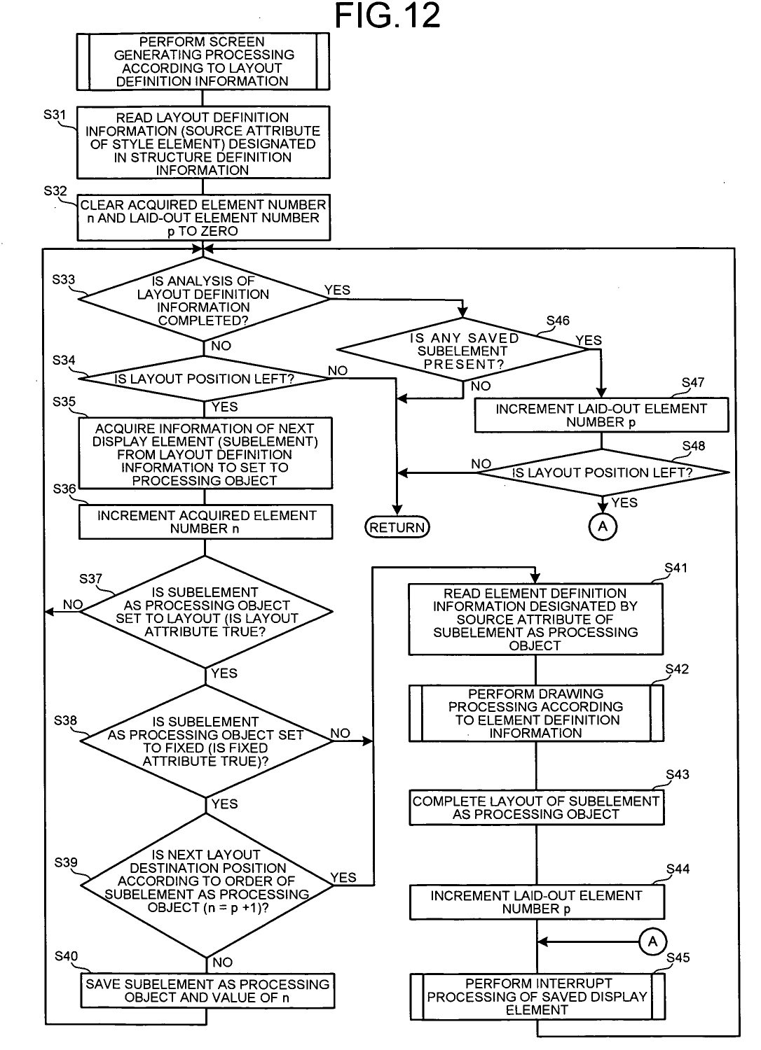

FIG. 11 is a flowchart of processings executed by the CPU 11 when the image processor 10 allows the display unit to display the screen. The CPU 11 starts the processings of the flowchart in FIG. 11, when the display unit needs to display any screen due to a user's operation, reception of an external command, or the like. Then, at step S11, the CPU 11 reads structure definition information defining a screen structure to be displayed and analyzes an XML structure to grasp the kinds and the number of elements included in the structure definition information and relative positions among the elements.

Next, at step S12, the CPU 11 acquires data (graphic data) of a predetermined background image to store the data in a predetermined memory area of the RAM 13. Although not shown in the example of FIG. 6, when there is a difference in data size or a background among screens, the size or the background can be designated by the structure definition information. Thereafter, at step S13, the CPU 11 acquires an element representing a first display component from the structure definition information.

At step S14, the CPU 11 determines whether the acquired element is an element that represents a display component to be referred to the layout definition information, namely whether it is a style element.

When the acquired element is not a style element (“No” at step S14), the system control proceeds to step S15 to draw the image of the display component represented by the acquired element on an on-screen position indicated by a position attribute of the element. For example, this is the processing performed when the acquired element is a message element or a button element. The data of an image corresponding to each display component is separated from the data of FIGS. 6 to 10 to be stored in the NVRAM 14 or the like. The image is drawn on the image data acquired at step S12.

When the acquired element is a style element (“Yes” at step S14), the system control proceeds to step S16 to perform screen generating processing according to the layout definition information. The processing also uses the content of the style element acquired at step S13.

After step S15 or S16, the system control proceeds to step S17 to determine whether analysis of the structure definition information is completed, namely, whether drawings of all elements defining the display component in the structure definition information are completed. If the analysis is not completed (“No” at step S17), the CPU 11 acquires an element representing the next display component at step S18, and then the system control returns to step S14 to repeat the processing. When the analysis is completed (“Yes” at step S17), the system control proceeds to step S19. Throughout the processings so far, image data for a screen to be displayed can be generated in which necessary display components are written in the background image data.

At step 19, the CPU 11 determines whether there is any display element that was not laid out in the display area defined by the structure definition information in the screen generating processing according to the layout definition information at step S16. The determination can be done, for example, simply by comparison between the number of display elements to be laid out (the number of subelements with a layout attribute of “true”) and the number of display areas (the number of the widget elements of the style element). However, for some reason, if any display element cannot be laid out in some display areas, not all of the display elements can be laid out even if the number of the display elements is less than the number of the display areas.

When there is any display element that was not laid out in the display area (“YES” at step S19), a display component relating to page feeding is left on a generated screen at step S20 because the screen to be displayed needs page switching. In this case, no particular processing is necessitated, but step S20 is described to contrast with step S21.

When there is no display element that was not laid out in the display area (“NO” at step S19), the display component relating to page feeding is deleted from the generated screen at step S21 because page switching is not necessitated on the screen to be displayed. In this case, the page-feeding display component in the generated screen data can be painted out with a background color.

In any case, the system control proceeds to step S22 to allow the display unit of the operation panel 18 to display the screen according to the image data generated throughout the processings and then finishes the processings.

The image data generated throughout steps S11 to S21 in those processings is the screen data that define the content of the screen to be displayed by the display unit. The CPU 11 functions as a screen data generating unit throughout the processings. In the processing of step S22, the CPU 11 functions as a display controlling unit. The processing of step 16, which has not been explained in detail yet, has some characteristics.

FIG. 12 is a flowchart of the screen generating processing according to the layout definition information, as shown at step S16 of FIG. 11.

First, at step S31, the CPU 11 reads the layout definition information designated by the source attribute of the style element in the structure definition information to analyze the XML structure. Then, at step S32, an acquired element number n and a laid-out element number p are cleared. The number n is a variable indicating which subelement is being laid out in the described order in the layout definition information. The number p is a variable indicating to which layout position display elements have been laid out in the order of layout positions defined by the style element.

Thereafter, at step S33, the CPU 11 determines whether the analysis of the layout definition information is completed, namely, whether the processings of all subelements (including saving) are completed. The determination can be done by checking whether the acquired element number n has reached the number of the subelements included in the layout definition information.

Usually, at first, because the determination at step 33 is “NO”, the system control proceeds to step S34 to determine whether there is a layout position left without any display element laid out. The determination can be done by checking whether the laid-out element number p has reached the number of the widget elements of the style elements in the structure definition information.

Then, usually, at first, the determination at step S34 is “YES”. Thus, the system control proceeds to step S35 to acquire the information of the next display element, namely, an (n+1)-th subelement from the layout definition information, to set a processing object. Consequently, at step S36, the acquired element number n is incremented by one.

Thereafter, at step S37, the CPU 11 determines whether the subelement as the processing object is set to “layout”, namely, whether the layout attribute value is “true”. When the layout attribute value is not “true” (“NO” at step S37), the display element represented by the subelement as the processing object is not laid out in the display area. Accordingly, the system control returns to step S33 at this point. In other words, the CPU 11 stops the processing of the subelement as the present processing object to process the next subelement in the same manner if there is a subelement left as a not-yet processed object.

When the layout attribute value is “true” (“YES” at step S37), the system control proceeds to step S38, and the CPU 11 determines whether the subelement as the processing object is set to “fixed”, namely, whether the fixed attribute value is “true”. When the fixed attribute value is not “true” (“NO” at step S38), the layout position is not restricted. Accordingly, the system control proceeds to step S41 and later steps to lay out the display element represented by the subelement as the processing object in a (p+1)-th display area.

When the fixed attribute value is “true” (“YES” at step S38), the system control proceeds to step S39, and the CPU 11 determines whether the next layout destination is a position corresponding to the order of the subelement as the processing object. The subelement currently under processing is an nth element. In the case of “fixed”, the display element represented by the nth subelement should be laid out in an nth display area. Meanwhile, the next destination is the (p+1)-th display area, so that if n is P+1, the determination at step S39 becomes “YES”. In this case, also, it is obvious that display element layout can be immediately performed. Accordingly, as in the case of “NO” at step S38, the processings at step S41 and thereafter are performed.

When the determination at step S39 becomes “NO”, the CPU 11 saves the subelement as the processing object and the value of n in a predetermined buffer at step S40 to lay out a display element corresponding to the subelement as the processing object in an appropriate display area later, and the system control returns to step S33.

Meanwhile, at step S41, the CPU 11 reads the element definition information designated by the source attribute of the subelement as the processing object to analyze the XML structure, and performs drawing processing according to the element definition information at step S42.

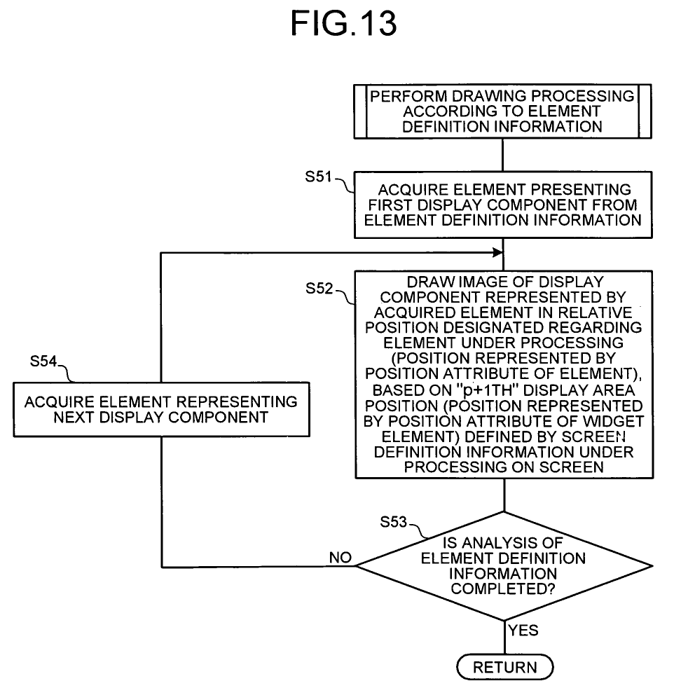

FIG. 13 is a flowchart of the drawing processing based on the element definition information.

As shown in FIG. 13, at each of steps S51 and S54, an element representing a display component is acquired from the element definition information. At step S52, an image of the display component represented by the element is drawn in the (p+1)-th display area defined by the screen definition information, on the screen. When drawings of all display components and the analysis of the element definition information are completed, the determination at step S53 becomes “YES” and thus, the system control returns to the initial processing.

The drawing processing at step S52 is performed on the image data acquired at step S12 of FIG. 11, where the layout position of the display component is equivalent to a relative position represented by the position attribute of the under-processed element with respect to the position of the display area represented by the position attribute of the widget elements.

With the processing of FIG. 13, the CPU 11 can lay out the display element represented by the element definition information in the (p+1)-th display area.

After the CPU 11 performs the drawing processing according to the element definition information at step S42, the system control proceeds to step S43 to complete the layout of the subelement as the processing object. Moreover, the CPU 11 increments the laid-out element number p at step S44. Due to the increment, any of previously saved subelements may satisfy the condition of n=p+1, so that the CPU 11 executes interrupt processing of the saved display elements at step S45.

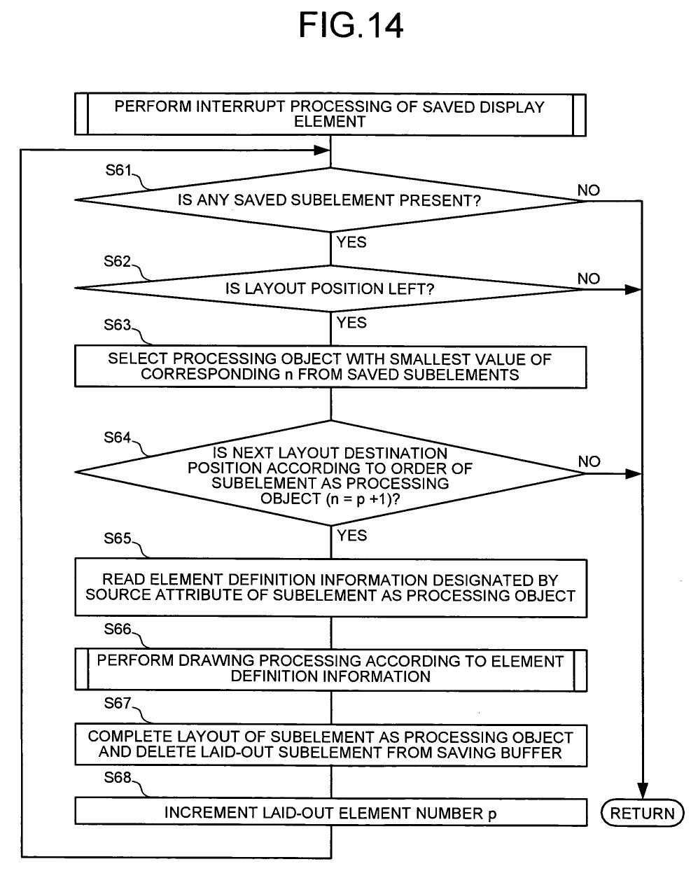

FIG. 14 is a flowchart of the interrupt processing of the saved display elements.

In the processing, first at step S61, the CPU 11 determines whether any saved subelement is present. When there is no saved subelement (“NO” at step S61), no subsequent processing is needed, so that the system control immediately returns to the initial processing. When there is any saved subelement (“YES” at step S61), processings at step S62 and thereafter are executed.

At step S62, as in step S34, the CPU 11 determines whether there is a layout position left without any display element laid out. When there is a layout position left (“YES” at step S62), the CPU 11 selects a processing object having a smallest value of the corresponding n from the saved subelements at step S63. Because the value p is increased one by one, if there is a subelement that satisfies the condition n=p+1, the subelement has the smallest value of the corresponding n.

At step S64, as in step S39 of FIG. 12, the CPU 11 determines whether the next layout destination is a position corresponding to the order of the subelement as the processing object. The determination at step 64 uses the value n saved at step S40, whereas p uses a value at the time of processing.

When the determination at step 64 becomes “YES”, it shows, at this point, that the display element represented by the subelement as the processing object can be laid out in the (p+1)-th display area. Accordingly, at steps S65 to S68, the CPU 11 executes the same processings as in steps S41 to S44 of FIG. 12 to lay out the display element represented by the subelement as the processing object therein. At step S67, the laid-out subelement is deleted from a saving buffer.

At step S68, when the value p is incremented, any other saved subelement may satisfy the condition n=p+1. Thus, the system control returns to step S61 to repeat the same processings.

When there is no layout position left (“No” at step S62), it shows that there is no more position for the layout of a display element. When the determination at step 64 becomes “NO”, the CPU 11 determines that there is no subelement that can be presently laid out among those saved, and the system control returns to the initial processing.

With the processings of FIG. 14, the CPU 11 can lay out the display element set to “fixed” defined by the element definition information in a specified display area as a fixed destination regardless of the layout positions of other display elements.

After the CPU 11 performs the interrupting processing of the saved display element at step S45, the system control returns to step S33 to repeat the processing of steps S33 to S46 to sequentially process each subelement included in the layout definition information until the analysis of the layout definition information is completed or all layout positions are filled.

At step S34, when no more display area is left to lay out a display element, even if any unprocessed or saved subelement is left, it cannot be laid out on the screen any longer. Accordingly, without any processing, the system control returns to the initial processing of FIG. 11.

At step S33, when the analysis of the layout definition information is completed, the system control proceeds to step S46 to determine whether any saved subelement is present. When any saved subelement is not present (“No” at step S46), the CPU 11 determines that the layouts of display elements represented by all subelements are completed, and the system control returns to the initial processings of FIG. 11.

Meanwhile, when any saved subelement is present (“Yes” at step S46), it is considered that the number of display elements to be laid out is small and thus, there is no display element laid out in a display area prior to a position for layout of the display element represented by the saved subelement. Accordingly, at step S47, the value p is incremented by one to skip one display area, thereby setting the next display area as a layout object area.

At step S48, as in step S34, the CPU 11 determines whether there is a layout position left without any display element laid out. In this case, the display area skipped due to the increment at step S47 is regarded as being filled with a display element. This is automatically considered if the determination at step S48 is made based on the value p.

When there is a layout position left (“YES” at step S48), the system control proceeds to step S45 to check the possibility of layouts for the saved subelements. Thereafter, the processings at steps S45 to S48 are repeated until all layouts of display elements represented by the saved elements are completed or all layout positions are filled. When either one of the conditions is satisfied, the determination at step S46 or step S48 becomes “NO”, so that the system control returns to the initial processings in FIG. 11.

Through the processings of FIG. 12, based on the layout definition information, the CPU 11 can lay out the display elements defined by the layout definition information in each on-screen display area defined by the structure definition information, according to a rule defined by the order of the subelements described in the layout definition information and the values of the fixed attribute and the layout attribute in each element.

The CPU 11 can make the determination at step S19 in FIG. 11, based on whether any unprocessed subelement is left when the system control returns to the processings of FIG. 11 from those of FIG. 12.

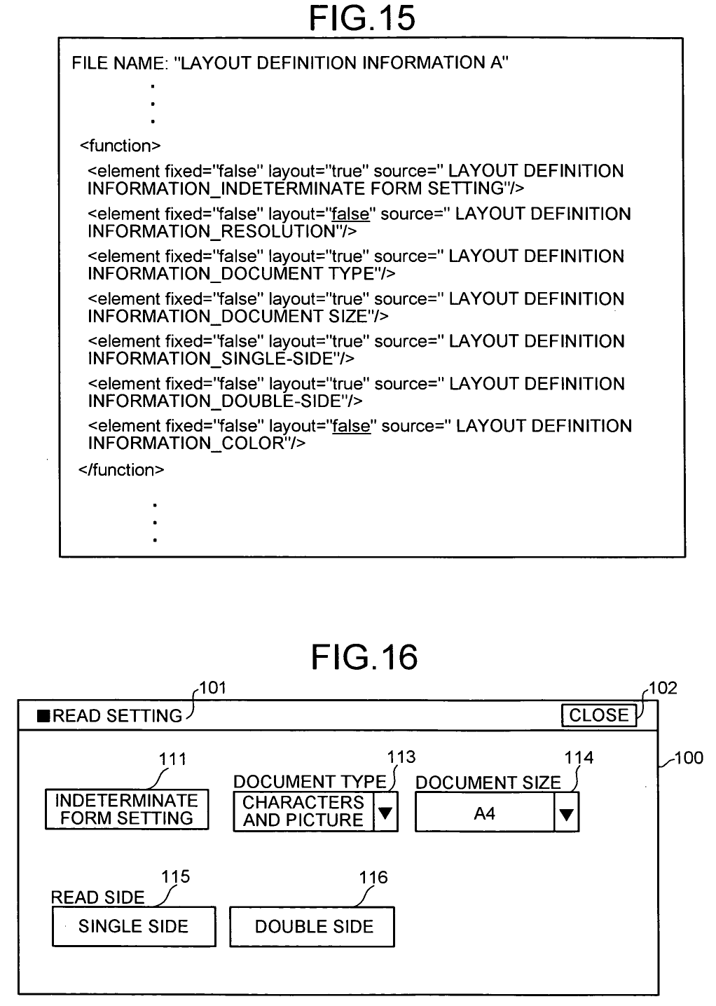

FIGS. 15 to 18 are schematic diagrams of examples of layout definition information and examples of display screens displayed using the layout definition information according to the processings.

The layout definition information of FIG. 15 is different from the information in FIG. 10, in that the layout attribute values of second and seventh subelements are changed to “false”. The second element represents the layout of the resolution setting element 12 in FIG. 2, and the seventh element represents the layout of a color setting element laid out in the next page on the screen in FIG. 2.

In a content displayed on a read setting screen of FIG. 16, the structure definition information and the element definition information are the same as those on the display screen in FIG. 2, whereas the layout definition information is changed to that of FIG. 15.

On the screen of FIG. 16, the entire screen structure and the layout positions of buttons on the screen are the same as those in FIG. 2. However, because the resolution setting element 112 is set to “no layout”, the resolution setting button 112a and the title message 112b included in the resolution setting element 112 are not displayed, and instead, the next adjacent button is shifted to and displayed in the position. With the layout change, a display space for the color setting element is made. However, the color setting element is also set to “no layout” and thus is not displayed. Furthermore, the number of display elements to be laid out is decreased to five, and all of them are laid out in the single page, so that no page element is displayed.

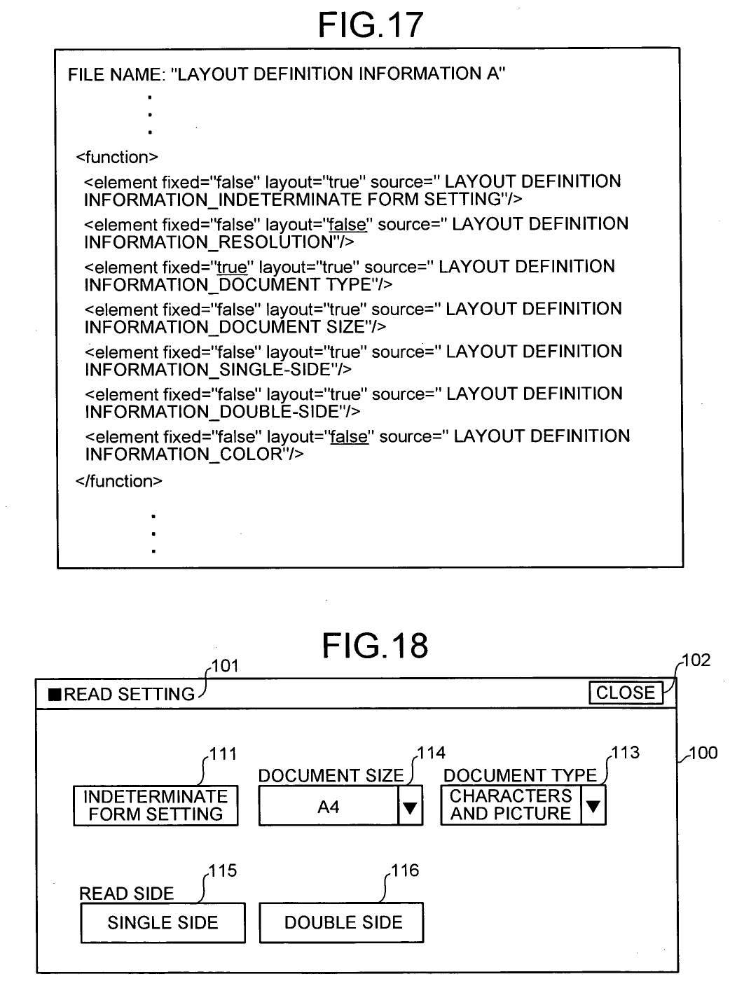

The layout definition information of FIG. 17 is different from that in FIG. 15, in that the fixed attribute of a third subelement representing the layout of the document type setting element 113 is changed to “true”.

In the display content of a read setting screen of FIG. 18, the structure definition information and the element definition information are the same as those displayed on the screen in FIG. 2, whereas the layout definition information is changed to that of FIG. 17.

In this case, the document type setting element 113 is set to “fixed”. Accordingly, although the resolution setting element 112 is not displayed, the position of the document type setting element 113 is not shifted. In other words, the document type setting element 113 is laid out in a display area 123 as the third display area of FIG. 7. An empty space formed by not displaying the resolution setting element 112 is filled with a document size setting element 114 behind that. The single-side setting element 115 and the double-side setting button (element) 116 are also shifted forward, whereby the display elements 114 to 116 are displayed.

According to the image processor 10, the layout definition information is used to define the layout rule of display elements in the reference positions on the screen. In this manner, without changing a basic screen structure, editing processings including a layout change of a component such as a button in a predetermined frame can be performed only by slightly changing the layout definition information. This can reduce stress on a user in terms of operation, content grasp, and the like when editing screen content.

Moreover, the relative positions between display components included in a single display element can always be maintained constant. Accordingly, like a unit of “a button for setting an item” and “the explanation of the button”, display components are collected to form a unit meaningful to a user to set a display element. This can prevent a situation where the button and the explanation are displayed in totally different positions and whereby the screen display content is incomprehensible to the user, even when the layout position of the display element is changed.

The basic screen structure can be changed by editing the structure definition information. Moreover, addition or changing of a display component, a functional change thereof, or the like can be performed in a single display element laid out by editing the element definition information.

Furthermore, after the priority order of display areas and the order of laying out display elements in the display areas are determined, display elements to be laid out are placed sequentially in the order of descending priorities. Thereby, even if the user deletes a display element somewhere in the middle, a display element behind the deleted one is shifted to the position and displayed on the screen, without changing any other setting. Thus, changing each of the layout positions of a plurality of display elements is not necessitated. Without such troublesome work, the method can prevent problems where the increase of pages due to unnecessary blanks on a display screen requires extra page feeding, and concerns about the blanks lower the operability of GUI.

Moreover, the display areas are laid out in the matrix and the structure definition information includes the information that represents the positions of the display areas in the matrix. This can make it easy to intuitively grasp positional relationships among the display areas.

An image processor 10′ according to a second embodiment of the present invention is explained.

The image processor 10′ includes layout definition information different from that in the image processor 10 according to the first embodiment. Therefore, screen construction processing according to the layout definition information is different from that in the first embodiment. Accordingly, the difference therebetween is mainly explained. In the explanation, the same constituents as those in the first embodiment are denoted by the same reference numerals as in the first embodiment.

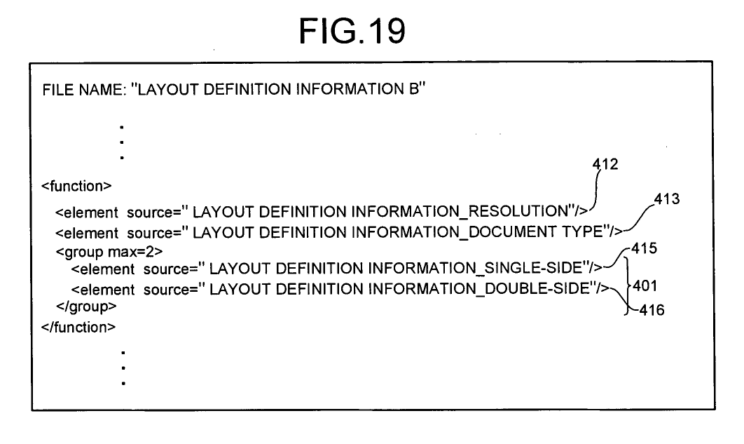

FIG. 19 is a schematic diagram of an example of the layout definition information used by the image processor 10′.

As in the image processor 10, each subelement of a function element in the image processor 10′ includes layout rule information relating to a single display element laid out in a display area defined by screen definition information.

However, in the image processor 10′, as another subelement of the function element, a group element 401 can also be described. The group element 401 designates the grouping of display elements. The group element 401 includes a plurality of subelements to be grouped (in the example of FIG. 19, subelements 415 and 416) are described. A max attribute value of the group element indicates the number of display elements included in the group.

When the grouped display elements are laid out in display areas arranged in the matrix as shown in FIG. 7, they are always laid out in the display areas of the adjacent columns in the same row. The group element 401 is data that defines such a layout rule.

Among display elements, for example, as in the single-side setting element 115 and the double-side setting element 116 of FIG. 2, a plurality of display elements carry out a single unitary performance. Accordingly, grouping such display elements enables them to be always laid out in mutually adjacent positions even when shifted to blank positions. Consequently, when customizing a screen display content, the content can be changed to an intuitively understandable and easily operationable one, without any particular consideration for the relative positions between display elements.

The format of a subelement is the same between when described as the subelement of the function element and when described as that of the group element. In the second embodiment, the display element does not have a function of designating the presence or the absence of “layout” and “fixed” settings. Thus, the subelement does not describe a layout attribute and a fixed attribute. Values of the attributes can be described; however, the following processings do not refer to the values thereof.

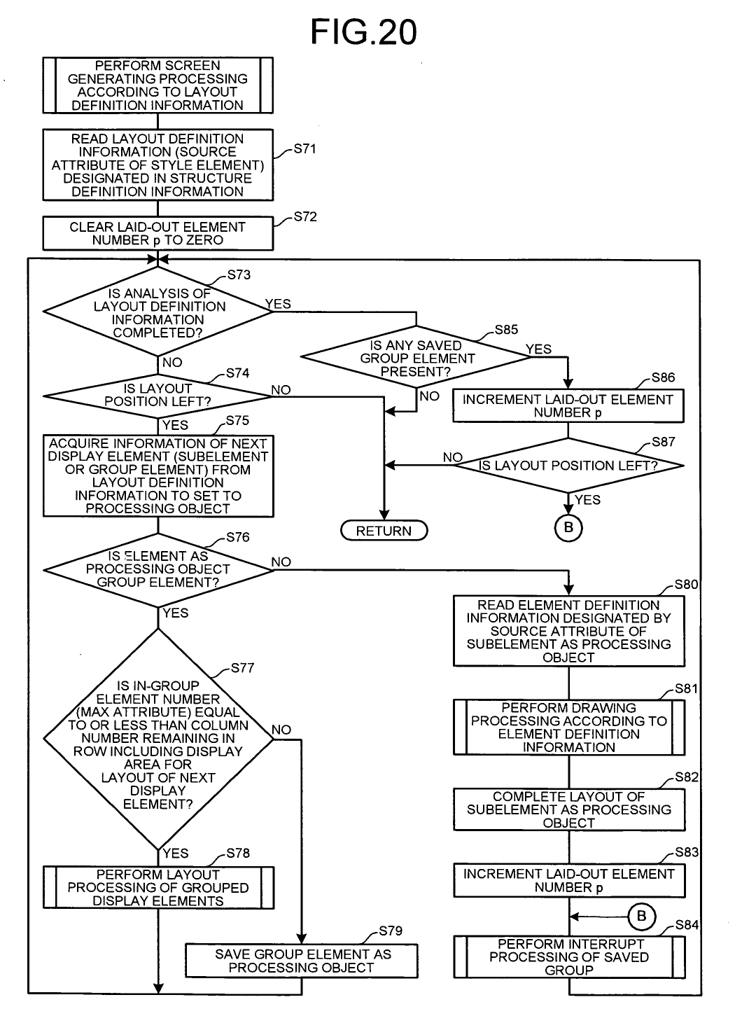

FIG. 20 is a flowchart of screen constructing processing according to layout definition information, executed by the CPU 11 of the image processor 10′.

In the image processor 10′, when the CPU 11 needs to allow the display unit to display any screen, the CPU 11 generates screen data through the processings shown in the flowchart of FIG. 11 to allow for display. However, the content of the screen constructing processing according to the layout definition information at step S16 is shown in the flowchart of FIG. 20.

First, at step S71, the CPU 11 reads layout definition information designated by the source attribute of a style element in structure definition information to analyze the XML structure. Then, at step S72, the CPU 11 clears a laid-out element number p explained in the processings of FIG. 12.

Thereafter, at step S73, the CPU 11 determines whether the analysis of the layout definition information is completed, namely, whether the processings of all subelements and the group elements (including saving) are completed. Through the analysis at step S71, elements included in the layout definition information can be grasped.

Usually, at first, because the determination at step 73 is, “NO”, the system control proceeds to step S74 to determine whether there is a layout position left without any display element laid out as in step S34 of FIG. 12.

Then, usually, at first, because the determination at step S74 is “YES”, the system control proceeds to step S75 to acquire the information of the next display element from the layout definition information to set an element as the processing object. In this case, a subelement or a group element can be the processing object.

Thereafter, at step S76, the CPU 11 determines whether the element as the processing object is a group element. When the element is a group element (“YES” at step S76), the system control proceeds to step S77.

At step S77, the CPU 11 determines whether the number of the elements in the group represented by the group element is equal to or less than the number of columns remaining in a row that includes a (p+1)-th display area as the next layout of a display element among display areas arranged in a matrix. As the number of the elements in the group, the number of subelements of the group element can be counted, or a max attribute value of the group element can be used.

When the determination at step S77 becomes “YES”, it shows that all the display elements in the group can be laid out in display areas positioned in the adjacent columns of the row including the (p+1)-th display area. Accordingly, the system control proceeds to step S78 to perform layout processing of the grouped display elements. Conversely, when the determination at step S77 becomes “NO”, at this point, all of the display elements in the group cannot be laid out in display areas positioned in adjacent columns of the same row. Thus, at step S79, the group element as the processing object is saved in a predetermined buffer to be laid out later.

After steps S78 and S79, the system control returns to step S73 to repeat the processings. In other words, if any yet-unprocessed subelement or group element is left, the next element is set to a processing object to perform the same processings.

When the determination at step S76 becomes “NO”, the processing object is the subelement, so that the CPU 11 performs processings for laying out a display element represented by the subelement in the (p+1)-th display area at steps S80 to S83, as in the steps S41 to S44 of FIG. 12. Then, due to an increment at step s83, the position of the (p+1)-th display area is shifted from the tail of the row to the top of the next row, so that any of saved group elements can be laid out. Thus, the CPU 11 performs interrupt processing of the group saved at step S84.

Thereafter, system control returns to step S73 to repeat the processings.

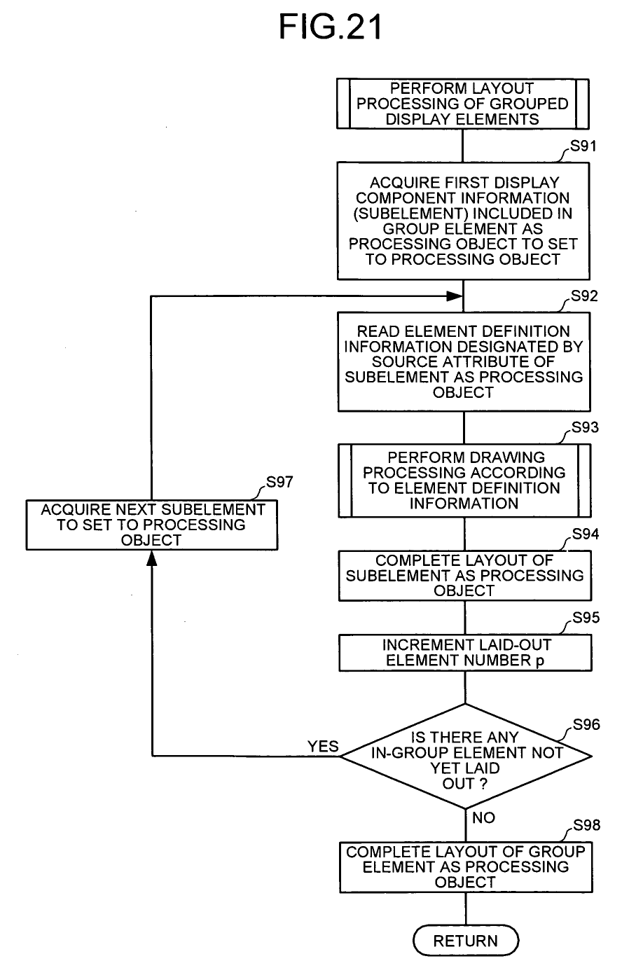

FIG. 21 is a flowchart of the layout processing of the grouped display elements, executed at step S78 of FIG. 20.

As shown in FIG. 21, at each of steps S91 and S97, the CPU 11 acquires subelements representing the display elements included in the group element as the processing object one by one. Then, at steps S92 to S95, the display element represented by the subelement is laid out in the (p+1)-th display area, as in steps S41 to S44 of FIG. 12. At step S93, drawing processing according to element definition information as shown in FIG. 13 is executed. After completion of the layouts (drawings) of all display elements in the group, the determination at step S96 becomes “NO”. Accordingly, at step S98, the CPU 11 determines that the layout of the group element as the processing object is completed, and the system control returns to the initial processing step.

Thus, the display elements of a single group can be laid out in display areas of adjacent columns of the same row. In the processings of FIG. 21, because the presence of blank display areas sufficient for such layout of the display elements in a single group is already confirmed, confirmation processing is not necessitated during those processings.

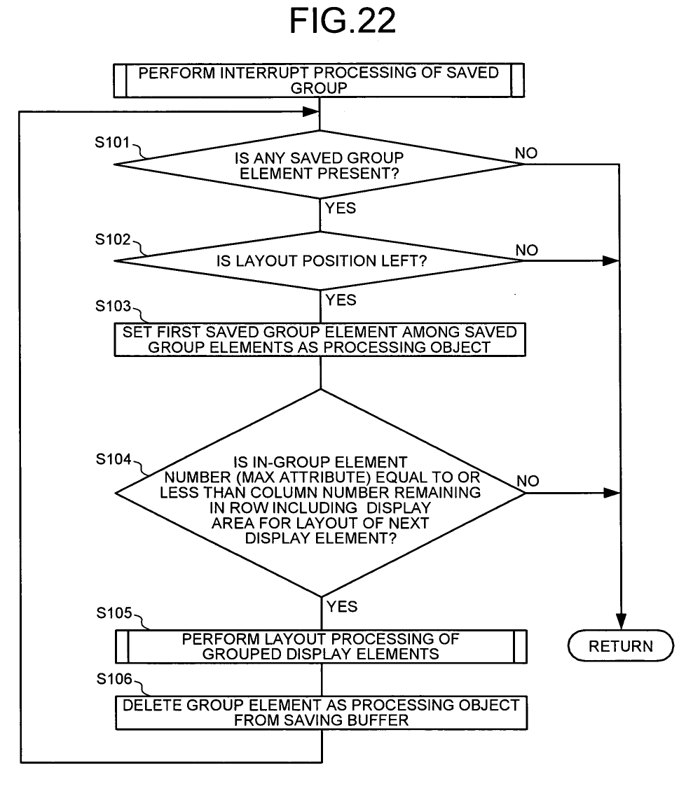

FIG. 22 is a flowchart of the interrupt processing of the saved group executed at step S84 of FIG. 20.

First, at step S101, the CPU 11 determines whether any saved group element is present. When there is no saved group element (“NO” at step S101), processings thereafter are not necessitated, so that the system control immediately returns to the initial processing. When there is a saved group element (“YES” at step S101), the system control proceeds to step S102 and later steps.

At step S102, as in step S74 of FIG. 20, the CPU 11 determines whether any layout position is left without any display element laid out. When there is a layout position left (“YES” at step S102), at step S103, a first saved group element among saved group elements is set as a processing object.

At step S104, as in step S77 of FIG. 20, the CPU 11 determines whether the number of the elements in a group represented by the group element is equal to or less than the number of columns remaining in a row that includes the (p+1)-th display area for next laying out a display element. When the determination at step 104 becomes “YES”, at step S105, the CPU 11 executes the layout processing of the grouped display elements in FIG. 21 to lay out the display elements of the group represented by the group element in the display area. Next, at step S106, the group element as the processing object is deleted from the saving buffer. Thereafter, because it is also possible to subsequently lay out the display elements of the next group, the system control returns to step S101 to repeat the same processings.

When the determination at step 104 becomes “NO”, because the saved group elements cannot be laid out yet, the system control returns to the initial step without performing any layout processings. In this case, to maintain the context between groups, layouts of other group elements are not considered.

As a result, when the display elements of a single group can be laid out in display areas of adjacent columns of the same row in the matrix, the saved group elements can be laid out in that manner.

After step S84, the system control returns to step S73 to repeat the processings at steps S73 to S84 as sequentially process each of the subelements and each of the group elements included in the layout definition information until the analysis of the layout definition information is completed or all layout positions are filled.

At step S74, when no more display area is left to lay out a display element, even if any unprocessed or saved element is left, such an element cannot be laid out as a display element on the screen any longer. Accordingly, the system control returns to the initial processing in FIG. 11 without performing any processing.

At step S73, when the analysis of the layout definition information is completed, the system control proceeds to step S85 to determine whether any save group element is present when there is no saved group element (“No” at step S85), the CPU 11 determines that the layouts of display elements represented by all of the subelements and the group elements are completed, and thus system control returns to the initial processings of FIG. 11.

Meanwhile, when any saved group element is present (“Yes” at step S85), if the value p is incremented to allows the position of a display area for element layout to be shifted to the next row in the matrix, it is still possible to lay out the display element of the group represented by the saved group element.

Accordingly, the CPU 11 increments the value p by one at step S86 and determines at step S87 whether any layout position is present, as in step S48 of FIG. 12. When there is a layout position (“YES” at step 87), the system control proceeds to step S84 to check the possibility of layouts for the save group element. Then, the processings at steps S84 to S87 are repeated until the display element layout regarding the saved element is completed or all layout positions are filled. If either one of the conditions is satisfied, the determination at step S85 or S87 becomes “NO”, so that the system control returns to the initial processings in FIG. 11.

Throughout the processings of FIG. 20, the CPU 11 can lay out a display element defined by element definition information based on layout definition information in each on-screen display area defined by structure definition information, according to a rule defined by the described order of subelements and the grouping condition of group elements in the layout definition information.

The CPU 11 can make the determination at step S19 in FIG. 11, based on whether any unprocessed subelement or group element is left when the system control returns to the processings of FIG. 11 from those of FIG. 20.

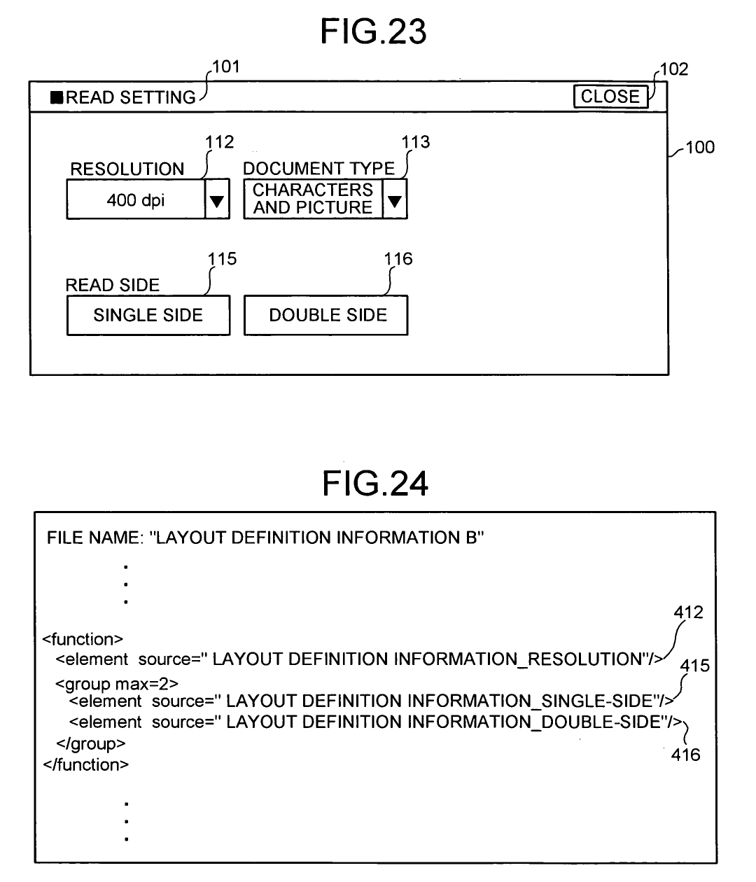

FIGS. 23 to 25 are schematic diagrams of an example of layout definition information used by the image processor 10′ and examples of display screens displayed using the layout definition information according to the processings.

FIG. 23 is a schematic diagram of a content displayed on a read setting screen, where the structure definition information and the element definition information are the same as those on the display screen in FIG. 2, and the layout definition information is the same as that of FIG. 19. The subelements 412, 413, 415, and 416 in the layout definition information of FIG. 19 represent the resolution setting element 112, the document type setting element 113, the single-side setting element 115, and the double-side setting element 116 in FIG. 23, respectively.

On the screen of FIG. 23, the entire screen structure and the layout positions of buttons on the screen are the same as those in FIG. 2. The resolution setting element 112 and the document type setting element 113, which are not grouped, are laid out in display areas sequentially starting from the first display area. However, the single-side setting element 115 and the double-side setting element 116, which follow the resolution setting element 112 and the document type setting element 113, are designated to grouping. If they are laid out sequentially in the third and the fourth display areas (display areas 123 and 124 in FIG. 7), they are arranged in the display areas of mutually different rows, which does not satisfy the layout condition of the grouping. Thus, layouts of the single-side setting element 115 and the double-side setting element 116 are started from the top area of a second row to arrange them in adjacent display areas in two columns (display areas 124 and 125 in FIG. 7). Consequently, buttons included in those display elements are also laid out in the adjacent positions, which make them easier to use as radio buttons.

The layout definition information of FIG. 24 does not include the subelement 413 included in the layout definition information of FIG. 19.

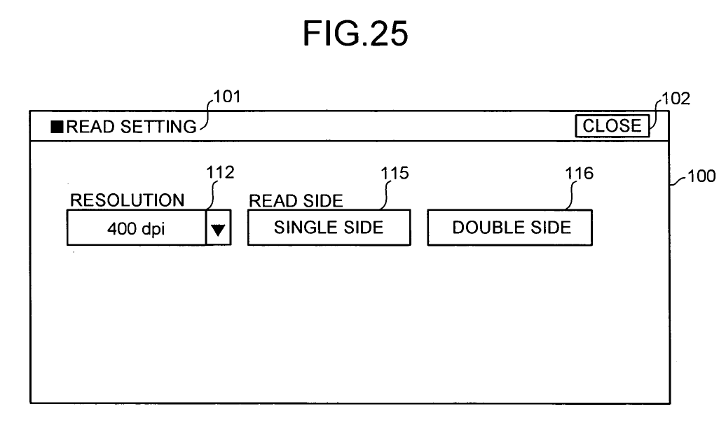

FIG. 25 is a schematic diagram of a content displayed on a read setting screen, where the structure definition information and the element definition information are the same as those on the screen in FIG. 2, and only the layout definition information is changed to that of FIG. 25.

In this case, after layout of the non-grouped resolution setting element 112 in the first display area, the single-side setting element 115 and the double-side setting element 116 can be laid out sequentially in columns remaining in the same row. As in FIG. 23, buttons included in the grouped display elements are laid out in mutually adjacent positions, so that they are easily usable as radio buttons.

The layout can be automatically performed by allowing the CPU 11 to refer to the grouping setting included in the layout definition information and the numbers of columns and rows included in the structure definition information without concrete layout destination is to be described in the layout definition information. Thus, if a user sets the grouping of display elements to be adjacently laid out in layout definition information, the display elements can be laid out in mutually adjacent positions, regardless of their relative positions with respect to other display elements.

Even when all of the grouped display elements cannot be laid out in display areas and their layouts are extended over a plurality of pages, they are not arranged across two pages. This can ensure that state of all of the grouped display elements can be referred to on a single screen.

Although the embodiments have been explained with reference to the drawings, it is obvious that the apparatus structures, the details of processing contents, the contents and use of the display screen, the data format, and the like are not restricted to those concretely explained in each of the embodiments.

For example, it is not always necessary to provide functions including settings of the presence or absence of “layout” and “fixed”, grouping, and page-element automatic deletion. Only part of the functions can be provided. Moreover, the description format of various data such as the structure definition information, the layout definition information, and the element definition information are not restricted to XML.

The embodiments have explained the example that defines the display areas arranged in the matrix based on the structure definition information. However, the display areas can be laid out in arbitrary positions, in arbitrary orders, and in arbitrary sizes. For example, display areas can be arranged also in the positions of the screen title message 101, the close button 102, the page feeding buttons 103 and 104, so that those components can also be laid out as display elements according to layout definition information.

When a display element is laid out in a display area, for example, part of the element protruded from the display area can be controlled not to be drawn, so that the display element is always fallen within a range of the display area. Alternatively, such a protrusion can be permitted regardless of the boundary of the display area.

Furthermore, a reference position defined by structure definition information can be defined not as an area but simply as positional coordinates as the references of relative positions between display elements laid out. In this case, laying out a display component included in a display element in a relative position with respect to a reference position can be regarded as laying out the display element in the reference position.

Furthermore, in the embodiments, throughout the processings up to step S17 of FIG. 11, screen image data is generated by drawing the display component. At this point, only screen data regarding the display component laid out on a screen and the absolute coordinates of the layout can be generated as screen data that defines a screen content. Then, after page element deletion or the like if needed, drawing based on the screen data can be performed, so as to generate display image data.

Furthermore, the screen data or the image data after drawing can be output to an external apparatus or stored in a storage medium to allow the other apparatus to display a screen content according to the screen data or the image data that is output or stored. In this case, the image processor simply has a function of generating screen data that defines the screen content based on structure definition information, element definition information, and layout definition information, which are generated by a user or provided by a manufacturer. Even only with this function, operability can be improved in screen editing.

Obviously, the applicable objects of the present invention are not restricted to image processors such as printers, fax machines, copiers, scanners, and digital multifunction products. The present invention can be applied as a unit that generates screen data defining a screen content displayed on a display unit included in each of arbitrary electronic apparatuses of network home electric appliances, vending machines, medical equipment, power supplies, air conditioning systems, measuring systems of gas, water, electricity supply, and the like, automobiles, aircrafts, all-purpose computers, and the like. Moreover, screen use is not restricted to GUI, and such a screen can be simply applied to an information screen.

Furthermore a computer program product according to the embodiments of the present invention stores a computer program that allows a computer to control hardware to function as the screen data generating apparatus. The CPU runs the computer program stored in the RAM from the computer program product, thereby achieving the same advantageous effects as those in the embodiments and the modified examples. Moreover, the computer program can also be provided by downloading or the like instead of the distribution of the computer program product.

Furthermore, the structures and the modified examples can be applied in appropriate combinations in consistent ranges.

According to one aspects of the invention, stress due to content editing on the screen of the display unit is reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A screen data generating apparatus that generates screen data that defines a content of a screen and includes a plurality of display elements, the screen data generating apparatus comprising:
a structure-definition-information acquiring unit that acquires structure definition information that defines a plurality of element layout positions on the screen;
an element-definition-information acquiring unit that acquires element definition information that defines contents of the display elements to be laid out on the screen;
a layout-definition-information acquiring unit that acquires layout definition information that defines which of the display elements is to be laid out on which of the element layout positions; and
a screen data generating unit that generates the screen data by laying out the display elements in the element layout positions on the screen according to the layout definition information.

2. The screen data generating apparatus according to claim 1, wherein
the structure definition information includes information on a priority order for each of the element layout positions,
the layout definition information includes information on a layout order indicative of an order of laying out the display elements in the element layout positions, and
the screen data generating unit lays out the display elements in the layout order in the element layout positions in the priority order.

3. The screen data generating apparatus according to claim 1, wherein
the element layout positions are arranged in a matrix, and
the structure definition information includes information indicative of a row number and a column number of each of the element layout positions in the matrix.

4. The screen data generating apparatus according to claim 1, wherein
the layout definition information includes layout true-false information indicative of whether to lay out each of the display elements, and
the screen data generating unit lays out the display elements based on the layout true-false information.

5. The screen data generating apparatus according to claim 1, wherein
at least one of the structure definition information and the layout definition information includes page element information indicative of a layout of a page element for page switching that is one of the display elements,
when the screen data generating unit lays out all of the display elements in the element layout positions according to the layout definition information, the screen data generating unit generates screen data without the page element laid out, and
when not all of the display elements are laid out in the element layout positions, the screen data generating unit generates screen data with the page element laid out according to the page element information.

6. The screen data generating apparatus according to claim 1, wherein
the layout definition information includes fixing true-false information indicative of whether to fix each of the display elements in a specified element layout position among the element layout positions, and
the screen data generating unit includes a display-element laying out unit that lays out the display elements based on the fixing true-false information.

7. The screen data generating apparatus according to claim 3, wherein
the layout definition information includes grouping information indicative of grouping of two or more of the display elements, and
the screen data generating unit includes a display-element-group laying out unit that lays out grouped display elements among the display elements in element layout positions that are adjacent in one row among the element layout positions.

8. An image processor comprising:
the screen data generating apparatus according to claim 1;
a display unit that displays a screen; and
a display control unit that allows the display unit to display a screen based on the screen data generated by the screen data generating apparatus.

9. A method of generating screen data that defines a content of a screen and includes a plurality of display elements to be displayed on a display unit, the method comprising:
acquiring structure definition information that defines a plurality of element layout positions on the screen;
acquiring element definition information that defines contents of the display elements to be laid out on the screen;
acquiring layout definition information that defines which of the display elements is to be laid out on which of the element layout positions; and
generating the screen data by laying out the display elements in the element layout positions on the screen according to the layout definition information.

10. The screen data generating method according to claim 9, wherein
the structure definition information includes information on a priority order for each of the element layout positions,
the layout definition information includes information on a layout order indicative of an order of laying out the display elements in the element layout positions, and
the generating includes laying out the display elements in the layout order in the element layout positions in the priority order.

11. The screen data generating method according to claim 9, further comprising arranging the element layout positions in a matrix, wherein
the structure definition information includes information indicative of a row number and a column number of each of the element layout positions in the matrix.

12. A computer program product comprising a computer usable medium having computer readable program codes embodied in the medium that, when executed, causes a screen data generating apparatus to execute:
acquiring structure definition information that defines a plurality of element layout positions on the screen;
acquiring element definition information that defines contents of the display elements to be laid out on the screen;
acquiring layout definition information that defines which of the display elements is to be laid out on which of the element layout positions; and
generating the screen data by laying out the display elements in the element layout positions on the screen according to the layout definition information.

13. The computer program product according to claim 12, wherein
the structure definition information includes information on a priority order for each of the element layout positions,
the layout definition information includes information on a layout order indicative of an order of laying out the display elements in the element layout positions, and
the generating includes laying out the display elements in the layout order in the element layout positions in the priority order.

14. The computer program product according to claim 12, further causing the screen data generating apparatus to execute, arranging the element layout positions in a matrix, wherein
the structure definition information includes information indicative of a row number and a column number of each of the element layout positions in the matrix.
